(19) United States
(12) Patent Application Publication
(10) Pub. No.: US 2016/0322657 A1
(43) Pub. Date: Nov. 3, 2016

(54) FUEL CELL SYSTEM AND CONTROL METHOD

(71) Applicant: BROTHER KOGYO KABUSHIKI KAISHA, Nagoya-shi (JP)

(72) Inventor: Yoshiaki Fukatsu, Nagoya-shi (JP)

(21) Appl. No.: 15/208,144

(22) Filed: Jul. 12, 2016

Related U.S. Application Data
(63) Continuation of application No. PCT/JP2014/059146, filed on Mar. 28, 2014.

(30) Foreign Application Priority Data
Feb. 13, 2014 (JP) 2014-025243

(51) Int. Cl. H01M 8/04223; H01M 8/04746; H01M 8/04537; H01M 8/0432; H01M 8/04119; H01M 8/04791

(52) U.S. Cl. CPC H01M 8/04231; H01M 8/04179; H01M 8/04798; H01M 8/04559; H01M 8/0432; H01M 8/04776

(57) ABSTRACT

A fuel cell system includes: a fuel cell stack; a fuel gas passage member in which the fuel cell stack is connected in a middle and a fuel gas supply source is connected to one end; a purge valve allowed to switch between an open state and a closed state; a detection part detecting a physical quantity relevant to at least one of the fuel gas supply source, the fuel gas passage member, and the fuel cell stack; a first purge part, at a given purge timing, controlling switchover between the open state and the closed state of the purge valve so as to perform first purge; a first determination part, determining whether second purge is to be performed after the first purge; and a second purge part, controlling switchover between the open state and the closed state of the purge valve so as to perform the second purge.

### CROSS-REFERENCE TO RELATED APPLICATIONS

This application is a Continuation application of PCT International Application No. PCT/JP2014/059146 which has an International filing date of Mar. 28, 2014 and designated the United States of America, and claiming priority on Patent Application No. 2014-025243 filed in Japan on Feb. 13, 2014. The contents of these applications are incorporated herein by reference in their entirety.

### FIELD

The present disclosure relates to a fuel cell system and a control method in which a purge valve employed for discharging water and impurities from a fuel gas passage performs opening and closing operation so that plural times of purge are performed.

### BACKGROUND AND SUMMARY

A fuel cell system includes a fuel cell stack in which a plurality of cells are stacked. The cell includes a membrane electrode assembly (an MEA) and a pair of separators respectively in contact with one face and the other face of the MEA. For example, the MEA includes a solid polymer electrolyte membrane, a cathode electrode in contact with one face of the solid polymer electrolyte membrane, and an anode electrode in contact with the other face of the solid polymer electrolyte membrane. For example, the fuel cell system is a solid polymer type fuel cell system including a solid polymer electrolyte membrane. In the solid polymer type fuel cell system, fuel gas (e.g., hydrogen) supplied to the anode electrode in each cell of the fuel cell stack and oxidation gas (e.g., air) supplied to the cathode electrode react with each other so that electric power and water are generated.

Hydrogen ions move from the anode electrode through the solid polymer electrolyte membrane to the cathode electrode and hence water is generated in the cathode electrode of each cell. A part of the generated water is back-diffused from the cathode electrode through the solid polymer electrolyte membrane to the anode electrode. When the water is accumulated in the fuel gas passage, supply of the fuel gas to the fuel cell stack is blocked. As a result, the electricity generation efficiency of the solid polymer type fuel cell system is degraded. Further, the fuel gas contains impurities such as carbon monoxide other than the fuel gas. When the concentration of impurities in the anode electrode surroundings in the fuel cell stack increases in association with consumption of the fuel gas, the partial pressure of the fuel gas relatively decreases so that the electricity generation efficiency decreases.

In the fuel cell system, a purge valve may be provided in the fuel gas passage. For example, in the case of a dead-end type fuel cell system, the purge valve is provided in the downstream of the fuel cell stack. Specifically, the purge valve is provided in a pipe through which the fuel gas discharged from the fuel cell stack passes. Water and impurities accumulated in the fuel gas passage are discharged to the outside when the purge valve is opened.

For example, a fuel cell system is disclosed having a configuration that at the time that water and impurities are discharged from a hydrogen circulation pipe (that is, a pipe through which the fuel gas passes), the pressure in the hydrogen circulation pipe is maintained somewhat higher than the atmospheric pressure. In this fuel cell system, the pressure in the hydrogen circulation pipe is set at the same level as the atmospheric pressure so that the amount of hydrogen discharged to the outside is reduced. Further, in the fuel cell system, switching of the purge valve is repeated two or three times with a given period so that momentum in the discharged purge gas is increased.

In the above-mentioned fuel cell system, a hydrogen tank storing hydrogen having been compressed to a high pressure is employed as a hydrogen supply source. The hydrogen tank is allowed to impart a sufficient pressure to the hydrogen supplied to the hydrogen circulation pipe. Thus, in the fuel cell system, even when plural times of purge have are repeated uniformly, the pressure in the inside of the hydrogen circulation pipe hardly decreases.

On the other hand, in another fuel cell system, a hydrogen absorbing alloy is employed as the hydrogen supply source. The hydrogen absorbing alloy stores hydrogen in a state of having reacted with metal. Release of the hydrogen is an endothermic reaction and hence the hydrogen absorbing alloy is difficult to supply hydrogen at a pressure as high as the case of a hydrogen tank. Thus, in the fuel cell system employing a hydrogen absorbing alloy, when plural times of purge have been repeated uniformly, a possibility arises that the pressure in the inside of the fuel gas passage member decreases excessively. This causes a possibility that the rate of supply of hydrogen to the fuel cell stack decreases so that the electricity generation efficiency of the fuel cell system is degraded.

An object of the present disclosure is to provide a fuel cell system and a control method in which the number of times of purge is allowed to be adjusted in accordance with the state of fuel gas.

According to one aspect of the example embodiment, a fuel cell system includes: a fuel cell stack in which a plurality of membrane electrode assemblies each having an anode electrode and a cathode electrode to which fuel gas and oxidation gas are supplied respectively for electric power generation are stacked with a plurality of separators; a fuel gas passage member in which the fuel cell stack is connected in a middle and a fuel gas supply source containing a hydrogen absorbing alloy is connected to one end; a purge valve arranged in the fuel gas passage member on a side opposite to the fuel gas supply source with respect to the fuel cell stack and allowed to switch between an open state and a closed state; a detection part provided in at least one of the fuel gas passage member and the fuel cell stack and detecting a physical quantity relevant to at least one of the fuel gas supply source, the fuel gas passage member, and the fuel cell stack; a first purge part, at a given purge timing, controlling switchover between the open state and the closed state of the purge valve so as to perform first purge; a first determination part, on the basis of a first detection result detected by the detection part at the time of the first purge, determining whether second purge is to be performed after the first purge; and a second purge part, in accordance with determination by the first determination part that the second purge is to be performed, controlling switchover between the open state and the closed state of the purge valve so as to perform the second purge.

According to one aspect of the example embodiment, a control method for a purge valve in a fuel cell system including a fuel cell stack in which a plurality of membrane electrode assemblies each having an anode electrode and a cathode electrode are stacked with a plurality of separators a fuel gas passage member in which the fuel cell stack is connected in a middle and a fuel gas supply source containing a hydrogen absorbing alloy is connected to one end a purge valve arranged in the fuel gas passage member on a side opposite to the fuel gas supply source with respect to the fuel cell stack and allowed to switch between an open state and a closed state and a detection part provided in at least one of the fuel gas passage member and the fuel cell stack and detecting a physical quantity relevant to at least one of the fuel gas supply source, the fuel gas passage member, and the fuel cell stack, the control method includes: a first purge step of, at a given purge timing, controlling switchover between the open state and the closed state of the purge valve so as to perform first purge; a first determination step of, on the basis of a first detection result detected by the detection part at the time of the first purge, determining whether second purge is to be performed after the first purge; and a second purge step of, in accordance with determination at the first determination step that the second purge is to be performed, controlling switchover between the open state and the closed state of the purge valve so as to perform the second purge.

According to one aspect of the example embodiment, A fuel cell system comprising: a stack in which a plurality of unit battery cells each including a membrane electrode assembly, having an anode electrode and a cathode electrode to which fuel gas and oxidation gas are supplied for electric power generation, are stacked together; a fuel gas passage member in which the stack is connected in a middle and a fuel gas supply source containing a hydrogen absorbing alloy is connected to one end; an anode side purge valve arranged in the fuel gas passage member on a side opposite to the fuel gas supply source with respect the stack; a detection part provided in at least one of the fuel gas passage member and the stack and detecting a physical quantity relevant to at least one of the fuel gas supply source, the fuel gas passage member, and the stack; a first purge part, at a given purge timing, controlling opening and closing of the anode side purge valve so as to perform first purge; a first determination part, on the basis of a first detection result detected by the detection part at the time of the first purge, determining whether second purge is to be performed after the first purge; a second purge part, in accordance with determination by the first determination part that the second purge is to be performed, controlling opening and closing of the anode side purge valve so as to perform the second purge; and a first comparison part comparing the first detection result with a first threshold, wherein the first determination part, if a comparison result of the first comparison part indicates that the first detection result is greater than the first threshold, determines that the second purge is not to be performed and, if the comparison result of the first comparison part indicates that the first detection result is not greater than the first threshold, determines that the second purge is to be performed, and the second purge part, if a comparison result of the first comparison part indicates that the first detection result is not greater than the first threshold, after a second detection result detected after obtaining the first detection result reaches a second threshold, performs control of performing the second purge.

According to the fuel cell system and the control method of the present disclosure, the number of times of purge is allowed to be adjusted in accordance with the state of fuel gas.

The above and further objects and features will more fully be apparent from the following detailed description with accompanying drawings.

### BRIEF DESCRIPTION OF THE SEVERAL VIEWS OF THE DRAWINGS

FIG. 1 is a schematic diagram illustrating arrangement of each configuration in an example of non-limiting fuel cell system of the present disclosure.

FIG. 2 is a perspective view illustrating a fuel cell stack provided in the above-mentioned fuel cell system.

FIG. 3 is an exploded perspective view illustrating a configuration of the above-mentioned fuel cell stack.

FIG. 4A is a plan view illustrating a front face of a separator constituting a cell.

FIG. 4B is a plan view illustrating a back face of a separator constituting a cell.

FIG. 5 is a sectional partial view illustrating a configuration of the above-mentioned cell.

FIG. 6 is a block diagram illustrating an electrical configuration of the fuel cell system of the present disclosure.

FIG. 7 is a flow chart illustrating control processing of purge according to a first embodiment.

FIG. 8 is a flow chart illustrating control processing of purge according to a second embodiment.

FIG. 9 is a flow chart illustrating control processing of purge according to a third embodiment.

FIG. 10 is a flow chart illustrating control processing of purge according to a fourth embodiment.

### DETAILED DESCRIPTION OF NON-LIMITING EXAMPLE EMBODIMENTS

### Overall Configuration of System

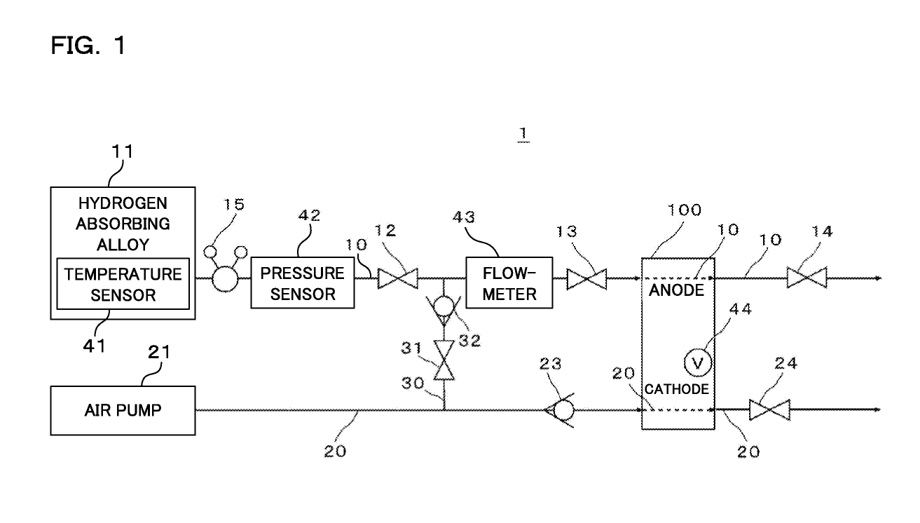

In FIG. 1, a fuel cell system 1 of the present embodiment includes a fuel cell stack 100, a fuel gas passage member 10, an oxidation gas passage member 20, and a substitution passage member 30. The fuel gas passage member 10 is connected to an inlet and an outlet on the anode side of the fuel cell stack 100. The oxidation gas passage member 20 is connected to an inlet and an outlet on the cathode side of the fuel cell stack 100. That is, the fuel cell stack 100 is arranged in the middle between the fuel gas passage member 10 and the oxidation gas passage member 20. The substitution passage member 30 connects together a position located in the fuel gas passage member 10 between the fuel cell stack 100 and a hydrogen absorbing alloy 11 and a position located in the oxidation gas passage member 20 between the fuel cell stack 100 and an air pump 21. Here, the fuel cell system 1 may be a solid polymer type fuel cell system.

<Configuration Relevant to Fuel Cell Stack>

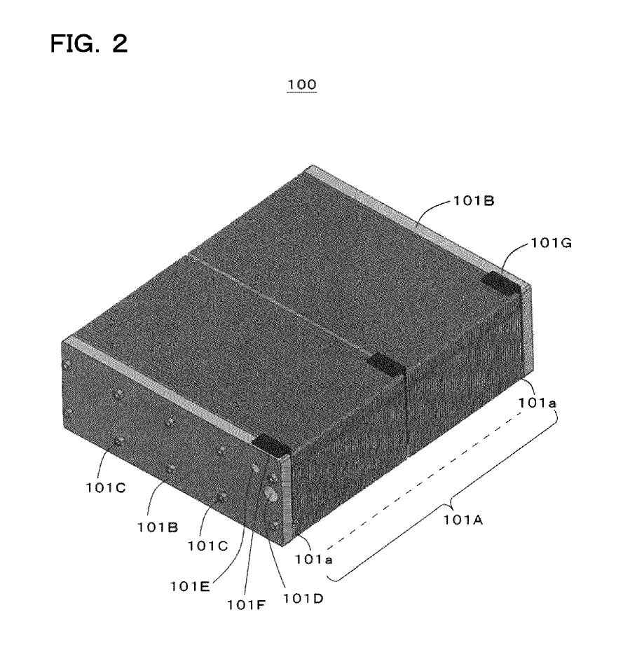

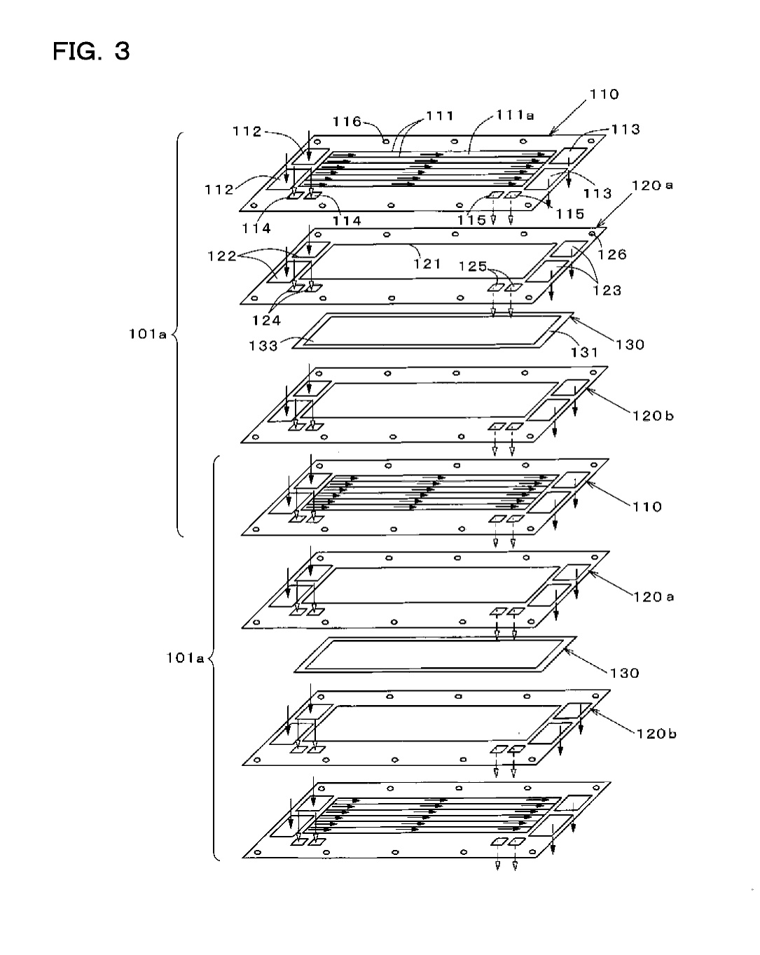

As illustrated in FIGS. 2 and 3, the fuel cell stack 100 includes a plurality of cells 101a and two end plates 101B. The plurality of cells 101a constitute a cell group 101A stacked in series. One of the two end plates 101B is arranged at one end of the cell group 101A. The other one of the two end plates 101B is arranged at the other end of the cell group 101A. A plurality of bolts 101C pass through the plurality of cells 101a and the two end plates 101B so as to fix together the plurality of cells 101a and the two end plates 101B. In one end plate 101B, an air inlet hole 101D and a hydrogen inlet hole 101E are formed. The air inlet hole 101D is in fluid communication with first through holes 112 of a separator 110 described later. The oxidation gas passage member 20 is connected to the air inlet hole 101D. The hydrogen inlet hole 101E is in fluid communication with later-described third through holes 114 of the separator 110. The fuel gas passage member 10 is connected to the hydrogen inlet hole 101E. An air discharge hole (not illustrated) and a hydrogen discharge hole (not illustrated) are formed in the other end plate 101B. The air discharge hole is in fluid communication with later-described second through holes 113 of the separator 110. The oxidation gas passage member 20 is connected to the air discharge hole. The hydrogen discharge hole is in fluid communication with later-described fourth through holes 115 of the separator 110. The fuel gas passage member 10 is connected to the hydrogen discharge hole. A collecting electrode plate 101F is provided between the one end plate 101B and the cell group 101A. A collecting electrode plate 101G is provided between the other end plate 101B and the cell group 101A. When an external electric load (such as an electric appliance) is electrically connected between the collecting electrode plate 101F and the collecting electrode plate 101G with a given voltage conversion circuit in between, the electric power generated by the fuel cell stack 100 is allowed to be supplied to the external electric load.

As illustrated in FIGS. 3 to 5, each cell 101a constituting the fuel cell stack 100 includes a membrane electrode assembly 130, two gaskets 120a and 120b, and two separators 110. The two gaskets 120a and 120b are provided respectively in the peripheral edge part of the membrane electrode assembly 130. One of the two separators 110 is in contact with one face of the membrane electrode assembly 130 with a gasket 120a in between. The other one of the two separators 110 is in contact with the other face of the membrane electrode assembly 130 with a gasket 120b in between.

<Membrane Electrode Assembly>

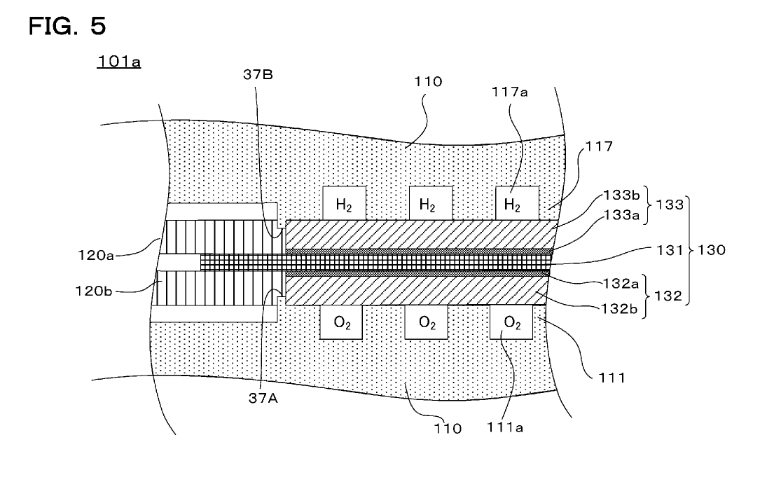

As illustrated in FIG. 5, the membrane electrode assembly 130 includes a solid polymer electrolyte membrane 131, a cathode electrode 132, and an anode electrode 133. The solid polymer electrolyte membrane 131 has electrical conductivity for protons. The solid polymer electrolyte membrane 131 selectively transports protons in a moisture state. The solid polymer electrolyte membrane 131 is constructed from a fluorine-based polymer such as Nafion (registered trademark) having a sulfonic acid group.

The anode electrode 133 is in contact with one face of the membrane electrode assembly 130. The anode electrode 133 includes a catalyst layer 133a and a gas diffusion layer 133b. The gas diffusion layer 133b has electrical conductivity and permeability for the fuel gas. In the present embodiment, hydrogen is employed as an example of the fuel gas. Here, it is sufficient that the fuel gas is a gas containing hydrogen. For example, the gas diffusion layer 133b is constructed from carbon paper or the like. The catalyst layer 133a is provided between one face of the membrane electrode assembly 130 and the gas diffusion layer 133b. The catalyst layer 133a contains a catalyst composed mainly of carbon powder carrying a platinum-based metal catalyst. For example, the catalyst layer 133a is formed by applying a paste in which a catalyst is dispersed in an organic solvent to the carbon paper constituting the gas diffusion layer 133b.

The cathode electrode 132 is in contact with the other face of the membrane electrode assembly 130. The cathode electrode 132 includes a catalyst layer 132a and a gas diffusion layer 132b. The gas diffusion layer 132b has electrical conductivity and permeability for the oxidation gas. In the present embodiment, air is employed as an example of the oxidation gas. Here, it is sufficient that the oxidation gas is a gas containing oxygen. For example, the gas diffusion layer 132b is constructed from carbon paper or the like. The catalyst layer 132a is provided between the other face of the membrane electrode assembly 130 and the gas diffusion layer 132b. The catalyst layer 132a contains a catalyst composed mainly of carbon powder carrying a platinum-based metal catalyst. For example, the catalyst layer 132a is formed by applying a paste in which a catalyst is dispersed in an organic solvent is applied on the carbon paper constituting the gas diffusion layer 132b.

<Separator>

The separator 110 is a member having a rectangular flat-plate shape. For example, the separator 110 is constructed from an electrically conductive material such as stainless steel, aluminum, and carbon. In the separator 110, formed are: a plurality of first passage walls 111, a plurality of second passage walls 117, two first through holes 112, two second through holes 113, two third through holes 114, and two fourth through holes 115.

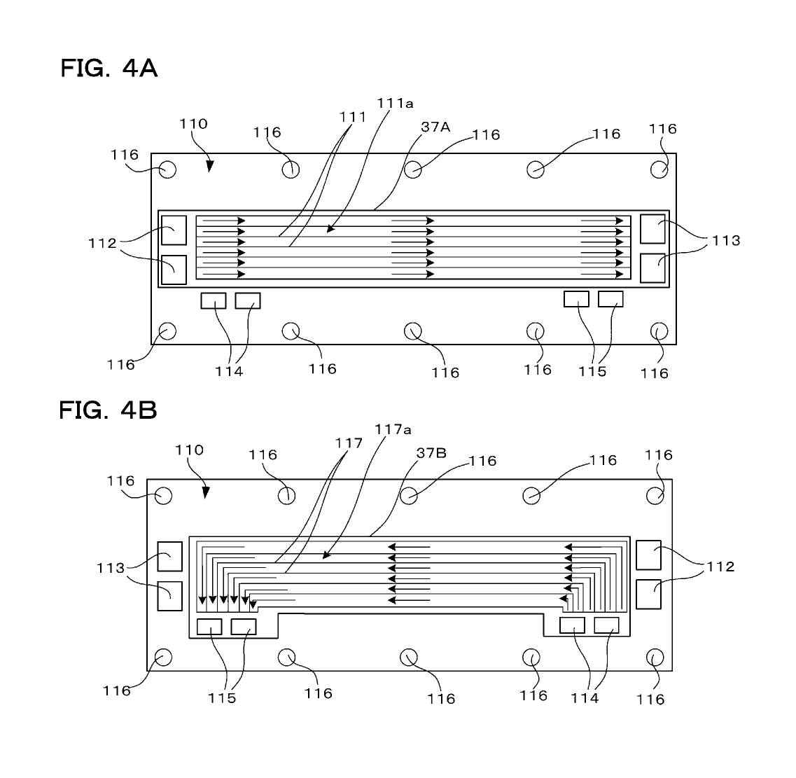

As illustrated in FIGS. 3 and 4, in the center in one face (e.g., the front face) of the separator 110, the plurality of first passage walls 111 are formed in parallel to each other with intervals in between. For example, the first passage wall 111 is a groove formed in the front face of the separator 110. The substantially rectangular region containing all the first passage walls 111 corresponds to the outer shape of the cathode electrode 132 of the membrane electrode assembly 130. A plurality of first passages 111a in the fuel cell stack 100 are formed by the individual first passage walls 111 and the cathode electrode 132 in contact with each top in the protrusion between two adjacent first passage walls 111. At one end of these first passages 111a, the two first through holes 112 are provided along the short side of the separator 110. Further, at the other end of these first passages 111a, the two second through holes 113 are provided along the short side of the separator 110. The air having passed through the first through holes 112 flows through the first passages 111a and is then supplied to the cathode electrode 132. The air having flowed through the first passages 111a, together with water generated in the cathode electrode 132 in association with power generation, passes through the second through holes 113. A gasket line 37A protruding in the thickness direction is formed in the front face of the separator 110. The gasket line 37A surrounds the outer periphery of the plurality of first passage walls 111, the two first through holes 112, and the two second through holes 113 without a discontinuity.

Further, in the center in the other face (e.g., the back face) of the separator 110, similarly to the front face, the plurality of second passage walls 117 are provided in parallel to each other with intervals in between. For example, the second passage wall 117 is a groove formed in the back face of the separator 110. In contrast to the passage walls 111 of straight type in the front face, the plurality of second passage walls 117 are of serpentine type in which both ends are bent at right angles respectively toward the third through holes 114 and the fourth through holes 115. The substantially rectangular region containing the plurality of second passage walls 117 corresponds to the outer shape of the anode electrode 133 of the membrane electrode assembly 130. A plurality of second passages 117a in the fuel cell stack 100 are formed by the individual second passage walls 117 and the anode electrode 133 in contact with each top in the protrusion between two adjacent second passage walls 117. The hydrogen having passed through the third through holes 114 flows through the second passages 117a and is then supplied to the anode electrode 133. The hydrogen having flowed through the second passages 117a passes through the fourth through holes 115. Similarly to the front face, a gasket line 37B protruding in the thickness direction is formed in the back face of the separator 110. The gasket line 37B surrounds the outer periphery of the plurality of second passages 117a, the two third through holes 114, and the two fourth through holes 115 without a discontinuity.

In the vicinity of each of the long sides opposite to each other in the separator 110, a plurality of through holes 116 are provided at equal intervals. In the present embodiment, for the purpose of improving the strength of the separator 110, the third through holes 114 and the fourth through holes 115 are provided individually in a region between two adjacent through holes 116.

<Gasket>

Each of the gaskets 120a and 120b is constructed from a rectangular sheet material having substantially the same size as the separator 110. Each of the gaskets 120a and 120b includes through holes 121 to 126. For example, the sheet material employed for forming the gaskets 120a and 120b may be an elastic material such as silicone rubber or elastomer formed remarkably thin. In the center of each of the gaskets 120a and 120b, a rectangular through hole 121 of the largest size is provided. The outer shape and the position of the through hole 121 correspond to those of a substantially rectangular region containing the plurality of first passage walls 111 formed in the front face of the separator 110 and the plurality of second passage walls 117 formed in the back face of the separator 110. Further, the outer shape of the through hole 121 corresponds also to the cathode electrode 132 and the anode electrode 133 provided in both faces of the membrane electrode assembly 130.

In the vicinities of the short sides opposite to each other in each of the gaskets 120a and 120b, at both ends of the rectangular through hole 121, two through holes 122 and two through holes 123 are respectively provided. The outer shapes and the positions of the two through holes 122 respectively correspond to those of the two first through holes 112 of the separator 110. Further, the outer shapes and the positions of the two through holes 123 respectively correspond to those of the two second through holes 113 of the separator 110.

In the vicinity of one long side of each of the gaskets 120a and 120b, two through holes 124 and two through holes 125 and are provided with intervals in between. The outer shapes and the positions of the two through holes 124 respectively correspond to those of the two third through holes 114 of the separator 110. Further, the outer shapes and the positions of the two through holes 125 respectively correspond to those of the two fourth through holes 115 of the separator 110.

In the vicinity of each of the long sides opposite to each other in each of the gaskets 120a and 120b, a plurality of through holes 126 are provided at equal intervals. The outer shapes and the positions of these through holes 126 respectively correspond to those of the individual through holes 116 of the separator 110.

As illustrated in FIGS. 3 and 5, the gasket 120a is located adjacent to the outer periphery of the anode electrode 133 and is in contact with one face of the solid polymer electrolyte membrane 131. The gasket 120a is pressed down by the gasket line 37B formed in the back face of the separator 110. The gasket 120a avoids a situation that the hydrogen flowing through the second passages 117a leaks from the cell 101a to the outside. The gasket 120b is located adjacent to the outer periphery of the cathode electrode 132 and is in contact with the other face of the solid polymer electrolyte membrane 131. The gasket 120b is pressed down by the gasket line 37A formed in the front face of the separator 110. The gasket 120b avoids a situation that the air flowing through the first passages 111a leaks from the cell 101a to the outside.

In FIGS. 2 and 3, the plurality of cells 101a are directly stacked and hence the first through holes 112 and the through holes 122 align in a straight line. Similarly, the third through holes 114 and the through holes 124, the second through holes 113 and the through holes 123, and the fourth through holes 115 and the through holes 125 individually align in a straight line. The hydrogen inlet hole 101E of one end plate 101B is in fluid communication with the third through holes 114 and the through holes 124 aligned in straight lines. The air inlet hole 101D of the one end plate 101B is in fluid communication with the first through holes 112 and the through holes 122 aligned in straight lines. The hydrogen discharge hole (not illustrated) of the other end plate 101B is in fluid communication with the fourth through holes 115 and the through holes 125 aligned in straight lines. The air discharge hole (not illustrated) of the other end plate 101B is in fluid communication with the second through holes 113 and the through holes 123 aligned in a straight line.

<Operation of Fuel Cell>

The hydrogen supplied through the hydrogen inlet hole 101E to the inside of the fuel cell stack 100 flows into the third through holes 114 aligned in straight lines in the stacking direction. The hydrogen flows through the third through holes 114 into the second passages 117a. The hydrogen having flowed into the second passages 117a is diffused in the plane direction of the membrane electrode assembly 130 by the diffusion layer 133b of the anode electrode 133 and then goes into contact with the catalyst layer 133a of the anode electrode 133. The hydrogen in contact with the catalyst layer 133a is dissociated into hydrogen ions and electrons by the catalyst contained in the catalyst layer 133a. The hydrogen ions are conducted through the solid polymer electrolyte membrane 131 and then reach the catalyst layer 132a of the cathode electrode 132. On the other hand, the electrons are extracted through the collecting electrode plate 101F to the outside. The hydrogen in contact with the anode electrode 133 goes along the second passages 117a to the fourth through holes 115 and is then discharged through the hydrogen discharge hole (not illustrated) to the outside of the fuel cell stack 100.

The air supplied through the air inlet hole 101D to the inside of the fuel cell stack 100 flows into the first through holes 112 aligned in straight lines in the stacking direction. The air flows through the first through holes 112 into the first passages 111a. The air having flowed into the first passages 111a is diffused in the plane direction of the membrane electrode assembly 130 by the diffusion layer 132b of the cathode electrode 132 and then goes into contact with the catalyst layer 132a of the cathode electrode 132. By the catalyst contained in the catalyst layer 132a, the oxygen contained in the air reacts with the hydrogen ions having been conducted through the solid polymer electrolyte membrane 131 and with the electrons having been extracted through the collecting electrode plate 101F and then conducted through an electric load and the collecting electrode plate 101G, so that water is generated. As a result of this electron transfer, electric power is generated. The air in contact with the cathode electrode 132, together with the generated water, goes along the first passages 111a to the second through holes 113 and is then discharged through the air discharge hole (not illustrated) to the outside of the fuel cell stack 100.

<Configuration Relevant to Fuel Gas Passage Member>

In FIG. 1, in the outside of the fuel cell stack 100, the fuel gas passage member 10 defines a passage for hydrogen serving as the fuel gas. The configuration of the fuel gas passage member 10 is not limited to a particular one as long as a passage for hydrogen is allowed to be defined. For example, as the fuel gas passage member 10, a hard or soft pipe or tube may be employed. For example, the material of such a hard pipe or tube may be metal such as stainless steel. For example, the material of such a soft pipe or tube may be engineering plastics or synthetic resin of diverse kind like polypropylene.

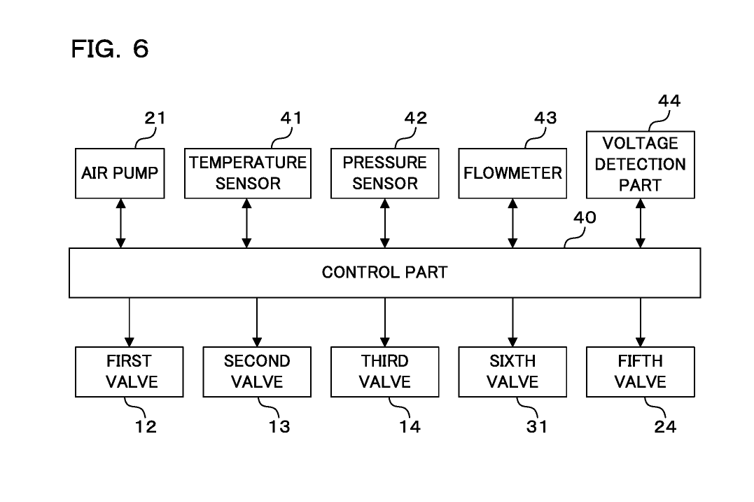

As illustrated in FIG. 1, in the fuel gas passage member 10, a hydrogen absorbing alloy 11, a regulator 15, a pressure sensor 42, a first valve 12, a flowmeter 43, a second valve 13, and a third valve 14 are arranged in this order from the upstream in the direction of hydrogen flow. The hydrogen absorbing alloy 11 is an example of the fuel gas supply source. The pressure sensor 42 and the flowmeter 43 are examples of the detection part. For example, as illustrated in FIG. 6, each of the first valve 12, the second valve 13, and the third valve 14 is constructed from a solenoid valve allowed to switch between an open state and a closed state in response to an instruction (e.g., a signal) from a control part 40. However, each valve employed in the present disclosure is not limited to a solenoid valve. In the present disclosure, in place of such a solenoid valve, for example, an electric operated valve whose opening state is allowed to be adjusted by a motor may be employed.

The hydrogen absorbing alloy 11 is arranged at the most upstream position of the fuel gas passage member 10. The hydrogen absorbing alloy 11 supplies hydrogen serving as the fuel gas to the fuel gas passage member 10. For example, the hydrogen absorbing alloy 11 is constructed such that an alloy allowed to absorb hydrogen is contained and sealed in the inside of a tank fabricated from an aluminum alloy or stainless steel. The given alloy allowed to absorb hydrogen may have a composition of diverse kind such as AB2 type, AB5 type, Ti—Fe-based, V-based, Mg alloy, Pb-based, and Ca-based alloy. In general, the hydrogen absorbing alloy 11 is releases hydrogen in association with an endothermic reaction. With increasing temperature of the hydrogen absorbing alloy 11, the hydrogen release rate per unit volume and unit time increases. On the other hand, with decreasing the temperature of the hydrogen absorbing alloy 11, the hydrogen release rate decreases.

The regulator 15 adjusts the pressure in the inside of the fuel gas passage member 10 to a value sufficient for power generation in the fuel cell stack 100. The regulator 15 controls the flow rate of the hydrogen supplied from the hydrogen absorbing alloy 11 to the fuel gas passage member 10. For example, the regulator 15 in the present embodiment adjusts the pressure in the inside of the fuel gas passage member 10 such as to exceed 50 kPa. If the pressure in the inside of the fuel gas passage member 10 exceeds 50 kPa, hydrogen at a flow rate sufficient for power generation is supplied to the fuel cell stack 100.

The first valve 12 is arranged in the fuel gas passage member 10 at a position located between the hydrogen absorbing alloy 11 and the substitution passage member 30. The first valve 12 goes into an open state at the time of startup of the fuel cell system 1 so as to cause the hydrogen supplied from the hydrogen absorbing alloy 11 to the fuel cell stack 100 to flow into the fuel gas passage member 10. Further, the first valve 12 goes into a closed state at the time of termination of the fuel cell system 1 so as to shut off the hydrogen supplied from the hydrogen absorbing alloy 11 to the fuel cell stack 100. If abnormality occurs in the closing operation of the third valve 14, the first valve 12 goes into a closed state so as to shut off the supply of hydrogen to the fuel cell stack 100.

The second valve 13 is arranged in the fuel gas passage member 10 at a position located between the substitution passage member 30 and the fuel cell stack 100. The second valve 13 goes into an open state at the time of startup of the fuel cell system 1 so as to cause the hydrogen supplied from the hydrogen absorbing alloy 11 to the fuel cell stack 100 to flow into the fuel gas passage member 10. Further, the second valve 13 goes into a closed state at the time of termination of the fuel cell system 1 so as to shut off the hydrogen supplied from the hydrogen absorbing alloy 11 to the fuel cell stack 100. If abnormality occurs in the closing operation of the third valve 14, the second valve 13 goes into a closed state so as to shut off the supply of hydrogen to the fuel cell stack 100. That is, the first valve 12 and the second valve 13 doubly prevent the leakage of hydrogen caused by the abnormality in the closing operation of the third valve 14.

The third valve 14 is arranged in the fuel gas passage member 10 connected to the downstream side of the fuel cell stack 100. Water generated by the fuel cell stack 100 and impurities whose concentration has increased in association with power generation stagnate in the inside of the fuel gas passage member 10 connected to the downstream side of the fuel cell stack 100. If the third valve 14 goes to an open state, the water and the impurities accumulated in the fuel gas passage member 10, together with hydrogen, are discharged (purged) to the outside. That is, the third valve 14 serves as a purge valve purging the fuel gas. If the first valve 12 and the second valve 13 are open and the third valve 14 is closed, in the fuel gas passage member 10, hydrogen is blockaded with the pressure adjusted by the regulator 15. That is, the fuel cell system 1 is of dead end type.

<Plurality of Detection Parts>

The fuel cell system 1 of the present embodiment has a configuration that the number of times of purge performed by the third valve 14 is controlled in accordance with the state of hydrogen. For the purpose of detecting the physical quantities relevant to the state of hydrogen, the fuel cell system 1 is provided with a plurality of detection parts such as a temperature sensor 41, a pressure sensor 42, a flowmeter 43, and a voltage detection part 44. On the basis of the detection result of at least one of the plurality of detection parts, the control part 40 illustrated in FIG. 6 is allowed to control the number of times of purge performed by the third valve 14.

As illustrated in FIG. 1, the temperature sensor 41 is provided in the hydrogen absorbing alloy 11. The pressure sensor 42 is arranged at a position located in the fuel gas passage member 10 between the regulator 15 and the first valve 12. The flowmeter 43 is arranged in the fuel gas passage member 10 between the substitution passage member 30 and the second valve 13. The voltage detection part 44 detecting a voltage (an FC voltage, hereinafter) between the collecting electrode plate 101F and collecting electrode plates 101G is provided in the fuel cell stack 100.

As illustrated in FIG. 6, the temperature sensor 41 detects the temperature of the hydrogen absorbing alloy 11 and then transmits the detection result to the control part 40. A resistance temperature sensor composed of platinum, thermistor, or the like or, alternatively, a thermocouple may be employed as the temperature sensor 41. The temperature of the hydrogen absorbing alloy 11 affects the rate of hydrogen released from the hydrogen absorbing alloy 11. With increasing temperature of the hydrogen absorbing alloy 11, the rate of hydrogen released from the hydrogen absorbing alloy 11 increases. On the other hand, with decreasing temperature of the hydrogen absorbing alloy 11, the rate of hydrogen released from the hydrogen absorbing alloy 11 decreases. On the basis of the detection result of the temperature sensor 41, the control part 40 is allowed to control the number of times of purge performed by the third valve 14.

The pressure sensor 42 detects the pressure in the inside of the fuel gas passage member 10 and then transmits the detection result to the control part 40. For example, a diaphragm pressure sensor or the like may be employed as the pressure sensor 42. The pressure in the inside of the fuel gas passage member 10 affects the flow rate of the hydrogen supplied from the hydrogen absorbing alloy 11 to the fuel gas passage member 10. With increasing pressure in the inside of the fuel gas passage member 10, the flow rate of the hydrogen supplied to the fuel cell stack 100 increases. On the other hand, with decreasing pressure in the inside of the fuel gas passage member 10, the flow rate of the hydrogen supplied to the fuel cell stack 100 decreases. On the basis of the detection result of the pressure sensor 42, the control part 40 is allowed to control the number of times of purge performed by the third valve 14.

As illustrated in FIG. 6, the flowmeter 43 detects the flow rate of the air or the hydrogen supplied to the fuel gas passage member 10 and then transmits the detection result to the control part 40. The configuration of the flowmeter 43 is not limited to a particular one. Then, for example, a flowmeter of thermal type, differential pressure type, area type, ultrasonic type, or the like may be employed. The flowmeter 43 of the present embodiment is a flowmeter of thermal type employing a thermistor.

In normal operation of the fuel cell system 1, the flowmeter 43 detects the flow rate of the hydrogen supplied to the fuel gas passage member 10. As illustrated in FIG. 6, the flowmeter 43 transmits the detected flow rate of hydrogen to the control part 40. On the basis of the detection result of the flowmeter 43, the control part 40 is allowed to control the number of times of purge performed by the third valve 14.

As illustrated in FIG. 6, the voltage detection part 44 detects the FC voltage and then transmits the detection result to the control part 40. The FC voltage mentioned here indicates an open circuit voltage in a state that electric power is not supplied from the fuel cell stack 100 to other equipments (not illustrated). In a case that the FC voltage has reached a given value at the time of startup of the fuel cell system 1, this situation indicates that hydrogen is supplied at a sufficient flow rate to the fuel cell stack 100. On the other hand, in a case that the FC voltage has not reached the given value at the time of startup of the fuel cell system 1, this situation indicates that hydrogen is not supplied at a sufficient flow rate to the fuel cell stack 100. On the basis of the detection result of the voltage detection part 44, the control part 40 is allowed to control the number of times of purge performed by the third valve 14.

<Configuration Relevant to Oxidation Gas Passage Member>

As illustrated in FIG. 1, in the outside of the fuel cell stack 100, the oxidation gas passage member 20 defines a passage for air serving as the oxidation gas. The configuration of the oxidation gas passage member 20 is not limited to a particular one as long as a passage for air is allowed to be defined. For example, as the oxidation gas passage member 20, a hard or soft pipe, tube, or the like may be employed. For example, the material of such a hard pipe or tube may be metal such as stainless steel. For example, the material of such a soft pipe or tube may be engineering plastics or synthetic resin of diverse kind like polypropylene.

As illustrated in FIG. 1, in the oxidation gas passage member 20, an air pump 21, a fourth valve 23, and a fifth valve 24 are arranged in this order from the upstream in the direction of air flow. The air pump 21 is an example of the oxidation gas supply source.

The air pump 21 is arranged at the most upstream position of the oxidation gas passage member 20. The air pump 21 supplies air serving as the oxidation gas, to the oxidation gas passage member 20. As illustrated in FIG. 6, for example, in response to an instruction (e.g., a signal) from the control part 40, the air pump 21 is controlled such as to be in any one of an operating state of supplying air to the oxidation gas passage member 20 and a stopped state of not supplying air to the oxidation gas passage member 20.

The fourth valve 23 permits a flow from one side of the oxidation gas passage member 20 to the other side and restricts a flow from the other side to the one side. In the present embodiment, the fourth valve 23 permits a flow from the upstream of the oxidation gas passage member 20 to the downstream, that is, from the air pump 21 side to the fuel cell stack 100 side. The fourth valve 23 shuts off a flow from the downstream of the oxidation gas passage member 20 to the upstream, that is, from the fuel cell stack 100 side to the air pump 21 side. As the fourth valve 23, for example, a check valve of arbitrary type such as poppet type, swing type, wafer type, lift type, ball type, and foot type may be employed. Here, as the fourth valve 23, a solenoid valve may be employed in place of such a check valve.

The fifth valve 24 is arranged in the oxidation gas passage member 20 connected to the downstream side of the fuel cell stack 100. If being in an open state, the fifth valve 24 discharges to the outside the water generated on the cathode side of the fuel cell stack 100, together with air. The fifth valve 24 goes into a closed state at the time of termination of power generation of the fuel cell stack 100. If the fifth valve 24 has gone into a closed state, discharge of air from the fuel cell stack 100 to the outside is shut off so that the humidity in the first passages 111a of the separator 110 through which the air flows is maintained. This avoids drying of the cathode electrode 132 of the solid polymer electrolyte membrane 131. As illustrated in FIG. 6, for example, the fifth valve 24 is constructed from a solenoid valve allowed to switch between an open state and a closed state in response to an instruction (e.g., a signal) from the control part 40. Here, each valve employed in the present disclosure is not limited to a solenoid valve. In the present disclosure, in place of such a solenoid valve, for example, an electric operated valve whose opening state is allowed to be adjusted by a motor may be employed.

<Configuration Relevant to Substitution Passage Member>

As illustrated in FIG. 1, the substitution passage member 30 is used for causing air to flow from the oxidation gas passage member 20 to the fuel gas passage member 10. The configuration of the substitution passage member 30 is not limited to a particular one as long as a substitution passage through which the air flows is allowed to be defined. For example, as the substitution passage member 30, a hard or soft pipe, tube, or the like may be employed. For example, the material of such a hard pipe or tube may be metal such as stainless steel. For example, the material of such a soft pipe or tube may be engineering plastics or synthetic resin of diverse kind like polypropylene.

As illustrated in FIG. 1, the substitution passage member 30 is connected to the fuel gas passage member 10 between the first valve 12 and the second valve 13 and to the oxidation gas passage member 20 between the air pump 21 and the fourth valve 23. A sixth valve 31 is arranged on the oxidation gas passage member 20 side of the substitution passage member 30. A seventh valve 32 is arranged on the fuel gas passage member 10 side of the substitution passage member 30.

The sixth valve 31 is used for causing the fuel gas passage member 10 and the oxidation gas passage member 20 to be in fluid communication with each other or shut off from each other. As illustrated in FIG. 6, for example, the sixth valve 31 is constructed from a solenoid valve allowed to switch between an open state and a closed state in response to an instruction (e.g., a signal) from the control part 40. Here, each valve employed in the present disclosure is not limited to a solenoid valve. In the present disclosure, in place of such a solenoid valve, for example, an electric operated valve whose opening state is allowed to be adjusted by a motor may be employed.

In normal operation of the fuel cell system 1, in accordance with the instruction from the control part 40, the sixth valve 31 goes into a closed state so as to shut off the fuel gas passage member 10 and the oxidation gas passage member 20 from each other. Thus, the air supplied from the air pump 21 flows through the oxidation gas passage member 20 to the cathode side of the fuel cell stack 100. On the other hand, at the time of termination of operation of the fuel cell system 1, in accordance with the instruction from the control part 40, the sixth valve 31 goes into an open state so as to bring the fuel gas passage member 10 and the oxidation gas passage member 20 into fluid communication with each other. Thus, a route is formed that passes through the oxidation gas passage member 20, the substitution passage member 30, and the fuel gas passage member 10. At that time, the air supplied from the air pump 21 flows from the oxidation gas passage member 20 through the substitution passage member 30 to the fuel gas passage member 10. After that, the air flows from the fuel gas passage member 10 to the anode side of the fuel cell stack 100 so that the hydrogen remaining on the second passages 117a of the separator 110 is discharged to the outside. That is, the hydrogen remaining in the inside the fuel gas passage member 10 and the fuel cell stack 100 is replaced with air.

The seventh valve 32 permits a flow from one side of the substitution passage member 30 to the other side and restricts a flow from the other side to the one side. That is, the seventh valve 32 permits the flow of air from the oxidation gas passage member 20 to the fuel gas passage member 10. The seventh valve 32 shuts off the flow of hydrogen from the fuel gas passage member 10 to the oxidation gas passage member 20. As the seventh valve 32, for example, a check valve of arbitrary type such as poppet type, swing type, wafer type, lift type, ball type, and foot type may be employed. Here, as the seventh valve 32, a solenoid valve may be employed in place of such a check valve.

<Control Part>

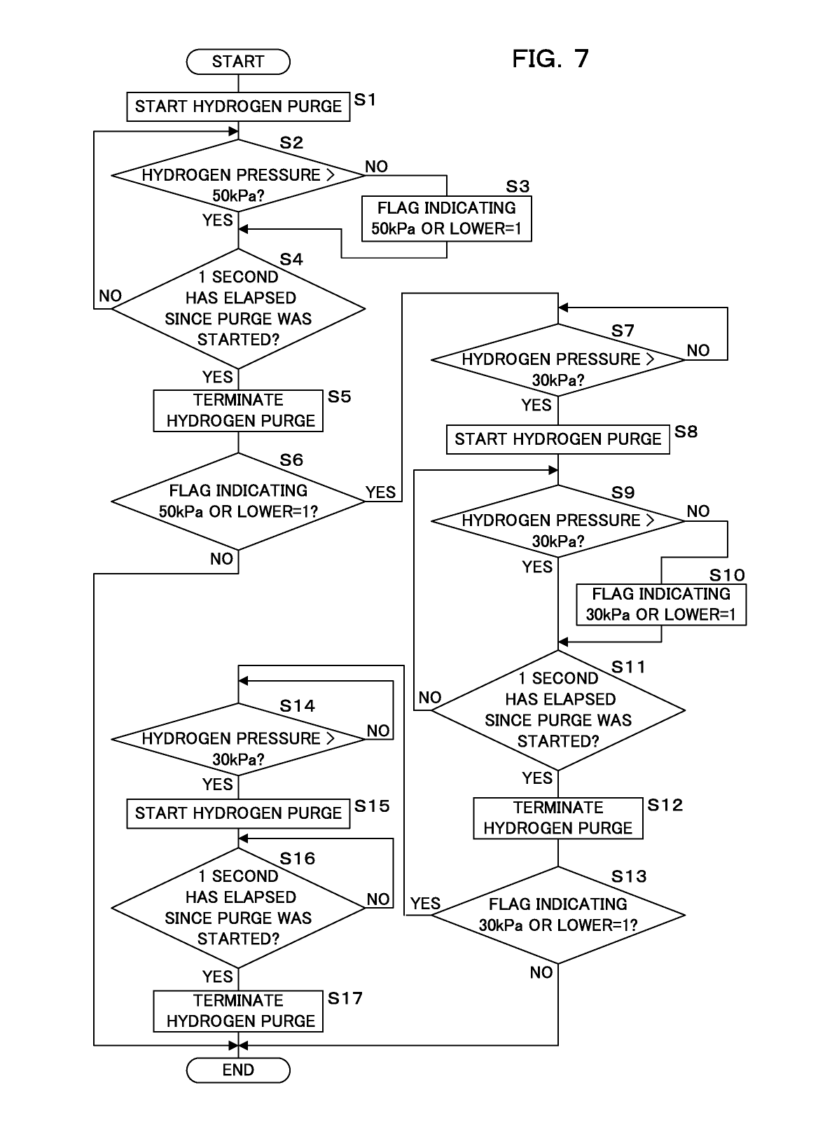

The control part 40 illustrated in FIG. 6 is electrically connected to the temperature sensor 41, the pressure sensor 42, the first valve 12, the flowmeter 43, the second valve 13, the voltage detection part 44, the third valve 14, the air pump 21, the fifth valve 24, and the sixth valve 31. The control part 40 transmits an instruction so as to control the opening and closing operation of the first valve 12, the second valve 13, the third valve 14, the fifth valve 24, and the sixth valve 31. The control part 40 transmits an instruction so as to control the operation of the air pump 21. The control part 40 receives the detection results from the temperature sensor 41, the pressure sensor 42, the flowmeter 43, and the voltage detection part 44. Then, on the basis of the detection result of at least one of the temperature sensor 41, the pressure sensor 42, the flowmeter 43, and the voltage detection part 44, the control part 40 is allowed to control the number of times of purge performed by the third valve 14. For example, the control part 40 is a circuit board containing: a microcomputer including a CPU and a storage part; and various electric circuits. For example, the various electric circuits include: driver circuits driving the first valve 12, the second valve 13, the third valve 14, the air pump 21, the fifth valve 24, and the sixth valve 31; conversion circuits converting the analog signals from the temperature sensor 41, the pressure sensor 42, the flowmeter 43, and the voltage detection part 44 and then and inputting them to the microcomputer. The storage part stores a dedicated program used for executing control processing in FIGS. 7 to 10 described later. For example, the storage part is a ROM, a RAM, or the like. Here, the control part 40 may include a dedicated electronic circuit (e.g., an ASIC) for executing the control processing in FIGS. 7 to 10, in place of or in addition to the microcomputer.

Here, in the present embodiment, the one control part 40 controls the opening and closing operation of the plurality of valves including the third valve 14. Further, in the present embodiment, on the basis of the detection result of at least one of the plurality of detection parts, the one control part 40 controls the number of times of purge performed by the third valve 14. However, the configuration of the fuel cell system of the present disclosure is not limited to that provided with the one control part 40. The fuel cell system of the present disclosure may have a configuration that opening and closing control of the valves and control of the number of times of purge are performed by a plurality of control parts.

Here, the control part 40 corresponds to the first purge part, the first determination part, the second purge part, the first comparison part, the second determination part, the third purge part, the second comparison part.

<Control Processing for Number of Times of Purge According to the First Embodiment>

Next, control processing for the number of times of purge according to a first embodiment of the present disclosure is described below with reference to FIG. 7. On the basis of the detection result of the pressure sensor 42 among the plurality of detection parts described above, the fuel cell system 1 of the present embodiment controls the number of times of purge performed by the third valve 14.

Steps S1 to S17 illustrated in FIG. 7 are executed by the control part 40 illustrated in FIG. 1. Here, as described above, a configuration may be employed that the steps S1 to S17 illustrated in FIG. 7 are executed by a plurality of control parts.

<Outlines of Control Processing for Number of Times of Purge>

A flow of control processing for the number of times of purge according to the present embodiment is briefly described below. Steps S1 to S17 illustrated in FIG. 7 indicate control processing in which up to three times of purge is performed. Here, the purge indicates that the third valve 14 is brought into an open state so that the gas is discharged from the fuel gas passage member 10. Steps S1 to S6 indicate control processing of first purge. In the fuel cell system 1 of the present embodiment, one time of purge (the first purge) is performed in accordance with steps S1 to S6. The amount of gas discharged by the purge depends on the pressure in the inside of the fuel gas passage member 10. For example, after the first purge has been performed, if the pressure in the inside of the fuel gas passage member 10 is equal to or lower than 50 kPa adopted as a first threshold (YES at step S5), there is a possibility that water and impurities have not sufficiently been discharged from the fuel gas passage member 10. In such a case, second purge is performed in accordance with steps S7 to S13. Further, after the second purge has been performed, if the pressure in the inside of the fuel gas passage member 10 is equal to or lower than 30 kPa adopted as a second threshold (YES at step S13), third purge is performed in accordance with steps S14 to S17. By the control processing of steps S1 to S17, water and impurities are allowed to sufficiently be discharged from the fuel gas passage member 10 without excessive reduction in the pressure in the inside of the fuel gas passage member 10. That is, the fuel cell system 1 of the present embodiment is allowed to perform plural times of purge in a state of avoiding a situation that the supply of hydrogen to the fuel cell stack 100 is unintentionally stopped. As a result, the electricity generation efficiency of the fuel cell system 1 is not degraded by the plural times of purge. Here, the values of the first threshold and the second threshold are examples and may suitably be set up in accordance with the specification of the fuel cell system 1.

The control processing for the number of times of purge according to the present embodiment is performed at the time of startup and in normal operation of the fuel cell system 1. At the time of startup of the fuel cell system 1, by performing the control processing for the number of times of purge according to the present embodiment, the air having been supplied to the inside of the fuel gas passage member 10 at the time of termination of operation of the fuel cell system 1 is replaced with hydrogen. Further, in normal operation of the fuel cell system 1, by performing the control processing for the number of times of purge according to the present embodiment, water and impurities are discharged from the fuel gas passage member 10. Steps S1 to S17 illustrated in FIG. 7 are described below in detail.

<First Purge>

At step S1, the control part 40 starts the first purge. In order to start the first purge, the control part 40 transmits an instruction of performing opening operation to the first valve 12, the second valve 13, and the third valve 14. In the case of startup of the fuel cell system 1, the first valve 12, the second valve 13, and the third valve 14 transit from a closed state to an open state (that is, perform opening operation).

Further, in the case of normal operation of the fuel cell system 1, the first valve 12 and the second valve 13 already in an open state maintain the open state, whereas the third valve 14 performs opening operation. Further, the control part 40 transmits an instruction of performing closing operation to the sixth valve 31. In the case of startup of the fuel cell system 1, the sixth valve 31 transits from an open state to a closed state (that is, performs closing operation). Further, in the case of normal operation of the fuel cell system 1, the sixth valve 31 already in a closed state maintains the closed state. Then, the control part 40 advances the control processing to step S2. At step S2, on the basis of the detection result received from the pressure sensor 42, the control part 40 determines whether the pressure in the inside of the fuel gas passage member 10 detected by the pressure sensor 42 exceeds 50 kPa serving as the first threshold.

At step S2, if the control part 40 determines that the pressure in the inside of the fuel gas passage member 10 is 50 kPa or lower (NO), the control part 40 advances the control processing to step S3. At step S3, the control part 40 sets to be “1” a flag indicating that the pressure in the inside of the fuel gas passage member 10 is 50 kPa or lower. The value of the flag set up at step S3 is temporarily stored in the RAM in the control part 40. At the time of start of the control processing of the present embodiment illustrated in FIG. 7, an initial value “0” is stored as the flag at step S3.

On the other hand, at step S2, if the control part 40 determines that the pressure in the inside of the fuel gas passage member 10 exceeds 50 kPa (YES), the control part 40 advances the control processing to step S4. At step S4, the control part 40 determines whether 1 second has elapsed since the first purge was started. For example, the measurement of time is performed by using a timer counter function built in the microcomputer in the control part 40.

At step S4, if the control part 40 determines that 1 second has not elapsed since the first purge was started (NO), the control part 40 repeats steps S2 and S3. At that time, if the control part 40 determines that the pressure in the inside of the fuel gas passage member 10 is 50 kPa or lower (NO at step S2), the control part 40 sets to be “1” the flag indicating that the pressure in the inside of the fuel gas passage member 10 is 50 kPa or lower (step S3).

On the other hand, at step S4, if the control part 40 determines that 1 second has elapsed since the first purge was started (YES), the control part 40 advances the control processing to step S5. At step S5, the control part 40 transmits an instruction of performing closing operation to the third valve 14 so as to terminate the first purge. The third valve 14 performs closing operation.

Then, the control part 40 advances the control processing to step S6. At step S6, the control part 40 determines whether the flag stored in the RAM in the control part 40 and indicating that the pressure in the inside of the fuel gas passage member 10 is 50 kPa or lower is “1”.

At step S6, if the control part 40 determines that the flag indicating that the pressure in the inside of the fuel gas passage member 10 is 50 kPa or lower is not “1” (NO), the control part 40 terminates the control processing of the present embodiment. This is because, if the pressure in the inside of the fuel gas passage member 10 exceeds 50 kPa, as a result of the first purge, it is expected that the air supplied to the inside of the fuel gas passage member 10 at the time of termination of operation of the fuel cell system 1 is replaced with hydrogen or alternatively water and impurities generated during normal operation of the fuel cell system 1 are sufficiently discharged.

On the other hand, at step S6, if the control part 40 determines that the flag indicating that the pressure in the inside of the fuel gas passage member 10 is 50 kPa or lower is “1” (YES), the control part 40 advances the control processing to step S7. This is because, if the pressure in the inside of the fuel gas passage member 10 is 50 kPa or lower, there is a possibility that the first purge is insufficient. In such a case, the control processing of the second purge at steps S7 to S13 is performed.

<Second Purge>

At step S7, on the basis of the detection result received from the pressure sensor 42, the control part 40 determines whether the pressure in the inside of the fuel gas passage member 10 detected by the pressure sensor 42 exceeds 30 kPa serving as the second threshold.

At step S7, if the control part 40 determines that the pressure in the inside of the fuel gas passage member 10 is 30 kPa or lower (NO), the control part 40 repeats the determination at step S7. The hydrogen absorbing alloy 11 releases hydrogen as time progresses. Thus, the pressure in the inside of the fuel gas passage member 10 increases as time progresses since the closing operation of the third valve 14 was performed at step S5. The control part 40 does not start the second purge until the pressure in the inside of the fuel gas passage member 10 exceeds 30 kPa (YES). If the second purge were started in a state that the pressure in the inside of the fuel gas passage member 10 is 30 kPa or lower, the pressure in the inside of the fuel gas passage member 10 excessively decreases. As a result, the supply of hydrogen to the fuel cell stack 100 is unintentionally stopped and hence the electricity generation efficiency of the fuel cell system 1 is degraded. Such a problem of degradation in the electricity generation efficiency is resolved by the control processing of step S7.

On the other hand, at step S7, if the control part 40 determines that the pressure in the inside of the fuel gas passage member 10 exceeds 30 kPa (YES), the control part 40 advances the control processing to step S8. At step S8, the control part 40 transmits an instruction of performing opening operation to the third valve 14. The third valve 14 performs opening operation at step S8 so that the second purge is started. Then, the control part 40 advances the control processing to step S9. At step S9, the control part 40 determines whether the pressure in the inside of the fuel gas passage member 10 detected by the pressure sensor 42 exceeds 30 kPa serving as the second threshold. At step S8, at the time that the opening operation of the third valve 14 is performed, in some cases, the pressure in the inside of the fuel gas passage member 10 decreases to 30 kPa or lower in accordance with the discharge of hydrogen. Thus, the control at step S9 has a meaning that whether the pressure in the inside of the fuel gas passage member 10 exceeds 30 kPa is checked after the start of the second purge.

At step S9, if the control part 40 determines that the pressure in the inside of the fuel gas passage member 10 is 30 kPa or lower (NO), the control part 40 advances the control processing to step S10. At step S10, the control part 40 sets to be “1” a flag indicating that the pressure in the inside of the fuel gas passage member 10 is 30 kPa or lower. The value of the flag set up at step S10 is temporarily stored in the RAM in the control part 40. At the time of start of the control processing of the present embodiment illustrated in FIG. 7, an initial value “0” is stored as the flag at step S10.

On the other hand, at step S9, if the control part 40 determines that the pressure in the inside of the fuel gas passage member 10 exceeds 30 kPa (YES), the control part 40 advances the control processing to step S11. At step S11, the control part 40 determines whether 1 second has elapsed since the second purge was started. For example, the measurement of time is performed by using a timer counter function built in the microcomputer in the control part 40.

At step S11, if the control part 40 determines that 1 second has not elapsed since the second purge was started (NO), the control part 40 repeats steps S9 and S10. At that time, if the control part 40 determined that the pressure in the inside of the fuel gas passage member 10 is 30 kPa or lower (NO at step S9), the control part 40 sets to be “1” the flag indicating that the pressure in the inside of the fuel gas passage member 10 is 30 kPa or lower (step S10).

On the other hand, at step S11, if the control part 40 determines that 1 second has elapsed since the second purge was started (YES), the control part 40 advances the control processing to step S12. At step S12, the control part 40 transmits an instruction of performing closing operation to the third valve 14. The third valve 14 performs closing operation at step S12 so that the second purge is terminated.

Then, the control part 40 advances the control processing to step S13. At step S13, the control part 40 determines whether the flag stored in the RAM in the control part 40 and indicating that the pressure in the inside of the fuel gas passage member 10 is 30 kPa or lower is “1”.

At step S13, if the control part 40 determines that the flag indicating that the pressure in the inside of the fuel gas passage member 10 is 30 kPa or lower is not “1” (NO), the control part 40 terminates the control processing of the present embodiment. This is because, if the pressure in the inside of the fuel gas passage member 10 exceeds 30 kPa, as a result of the second purge, the air supplied to the inside of the fuel gas passage member 10 at the time of termination of operation of the fuel cell system 1 is replaced with hydrogen or alternatively water and impurities generated during normal operation of the fuel cell system 1 are sufficiently discharged.

On the other hand, at step S13, if the control part 40 determines that the flag indicating that the pressure in the inside of the fuel gas passage member 10 is 30 kPa or lower is “1” (YES), the control part 40 advances the control processing to step S14. This is because, if the pressure in the inside of the fuel gas passage member 10 is 30 kPa or lower, there is a possibility that the second purge is insufficient. In such a case, the control processing of the third purge at steps S14 to S17 is performed.

<<Third Purge>>

At step S14, on the basis of the detection result received from the pressure sensor 42, the control part 40 determines whether the pressure in the inside of the fuel gas passage member 10 detected by the pressure sensor 42 exceeds 30 kPa serving as the second threshold.

At step S14, if the control part 40 determines that the pressure in the inside of the fuel gas passage member 10 is 30 kPa or lower (NO), the control part 40 repeats the determination at step S14. As described above, the hydrogen absorbing alloy 11 releases hydrogen as time progresses. Thus, the pressure in the inside of the fuel gas passage member 10 increases as time progresses since the closing operation of the third valve 14 was performed at step S12. The control part 40 does not start the third purge until the pressure in the inside of the fuel gas passage member 10 exceeds 30 kPa (YES). If the third purge were started in a state that the pressure in the inside of the fuel gas passage member 10 is 30 kPa or lower, the pressure in the inside of the fuel gas passage member 10 excessively decreases. As a result, the supply of hydrogen to the fuel cell stack 100 is stopped and hence the electricity generation efficiency of the fuel cell system 1 is degraded. Such a problem of degradation in the electricity generation efficiency is resolved by the control processing of step S14.

On the other hand, at step S14, if the control part 40 determines that the pressure in the inside of the fuel gas passage member 10 exceeds 30 kPa (YES), the control part 40 advances the control processing to step S15. At step S15, the control part 40 transmits an instruction of performing opening operation to the third valve 14. The third valve 14 performs opening operation at step S15 so that the third purge is started.

Then, the control part 40 advances the control processing to step S16. At step S16, the control part 40 determines whether 1 second has elapsed since the third purge was started. For example, the measurement of time is performed by using a timer counter function built in the microcomputer in the control part 40.

At step S16, if the control part 40 determined that 1 second has not elapsed since the third purge was started (NO), the control part 40 repeats the determination at step S16. That is, the third purge is performed at a pressure exceeding 30 kPa until 1 second elapses. Thus, the air in the fuel gas passage member 10 is replaced with hydrogen at the time of startup of the fuel cell system 1 or alternatively water and impurities generated during normal operation of the fuel cell system 1 are sufficiently discharged.

On the other hand, at step S16, if the control part 40 determines that 1 second has elapsed since the third purge was started (YES), the control part 40 advances the control processing to step S17. At step S17, the control part 40 transmits an instruction of performing closing operation to the third valve 14. The third valve 14 performs closing operation at step S17 so that the third purge is terminated. After that, the control part 40 terminates the control processing of the present embodiment.

<Control Processing for Number of Times of Purge According to Second Embodiment>

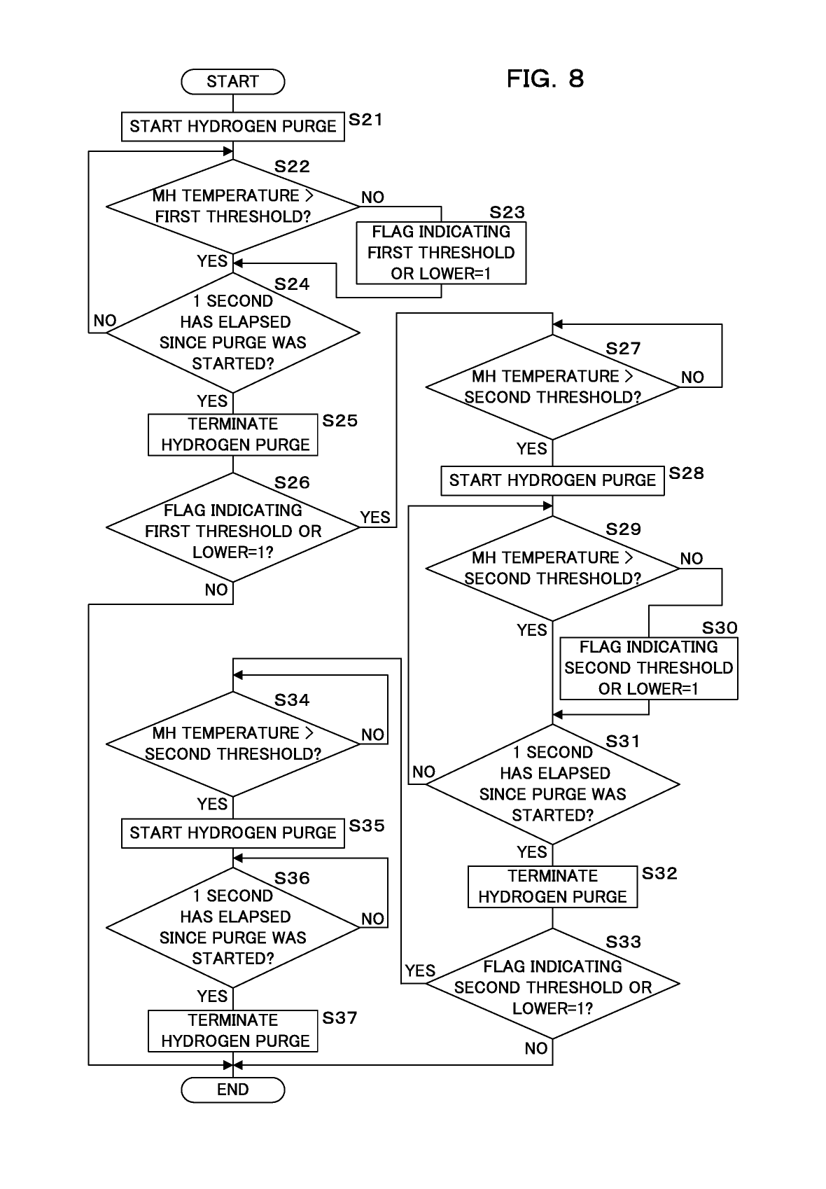

Next, control processing for the number of times of purge according to a second embodiment of the present disclosure is described below with reference to FIG. 8. On the basis of the detection result of the temperature sensor 41 provided in the hydrogen absorbing alloy 11 among the plurality of detection parts described above, the fuel cell system 1 of the present embodiment controls the number of times of purge performed by the third valve 14. In the following second embodiment, such control processing different from that of the first embodiment is described below. Then, detailed description is not given for control processing similar to that of the first embodiment.

Steps S21 to S37 illustrated in FIG. 8 correspond respectively to steps S1 to S17 of the first embodiment illustrated in FIG. 7. The present embodiment is different from the first embodiment in the point that each of the first threshold and the second threshold at steps S22, S23, S26, S27, S29, S30, S33, and S34 is the temperature (a MH temperature) of the hydrogen absorbing alloy 11. The rate of hydrogen released per unit time from the hydrogen absorbing alloy 11 is proportional to the temperature of the hydrogen absorbing alloy 11. Thus, the pressure of the hydrogen generated by the hydrogen absorbing alloy 11 corresponds to the temperature of the hydrogen absorbing alloy 11. Thus, in the present embodiment, on the basis of the MH temperature detected by the temperature sensor 41, the control part 40 determines whether the second purge is to be performed (steps S22, S23, S26, and S27) and whether the third purge is to be performed (steps S29, S30, S33, and S34).

Each of the MH temperatures adopted as the first threshold and the second threshold is set to be a value required for the anode side in the inside of the fuel cell stack 100 being filled with a sufficient amount of hydrogen. In the present embodiment, as a specific example, the first threshold is set to be 20 degrees C. and the second threshold is set to be 10 degrees C. Here, these values for the first threshold and the second threshold are merely examples. An MH temperature appropriate as each of the first threshold and the second threshold is determined in accordance with the capacity of the hydrogen absorbing alloy 11 and with the volume of a buffer portion in which the gas generated by the hydrogen absorbing alloy 11 temporarily stagnates.

According to the control processing of steps S21 to S37 illustrated in FIG. 8, similarly to the first embodiment, plural times of purge are allowed to be performed in a state of avoiding a situation that the supply of hydrogen to the fuel cell stack 100 is unintentionally stopped. As a result, the electricity generation efficiency of the fuel cell system 1 is not degraded by the plural times of purge.

<Control Processing for Number of Times of Purge According to Third Embodiment>

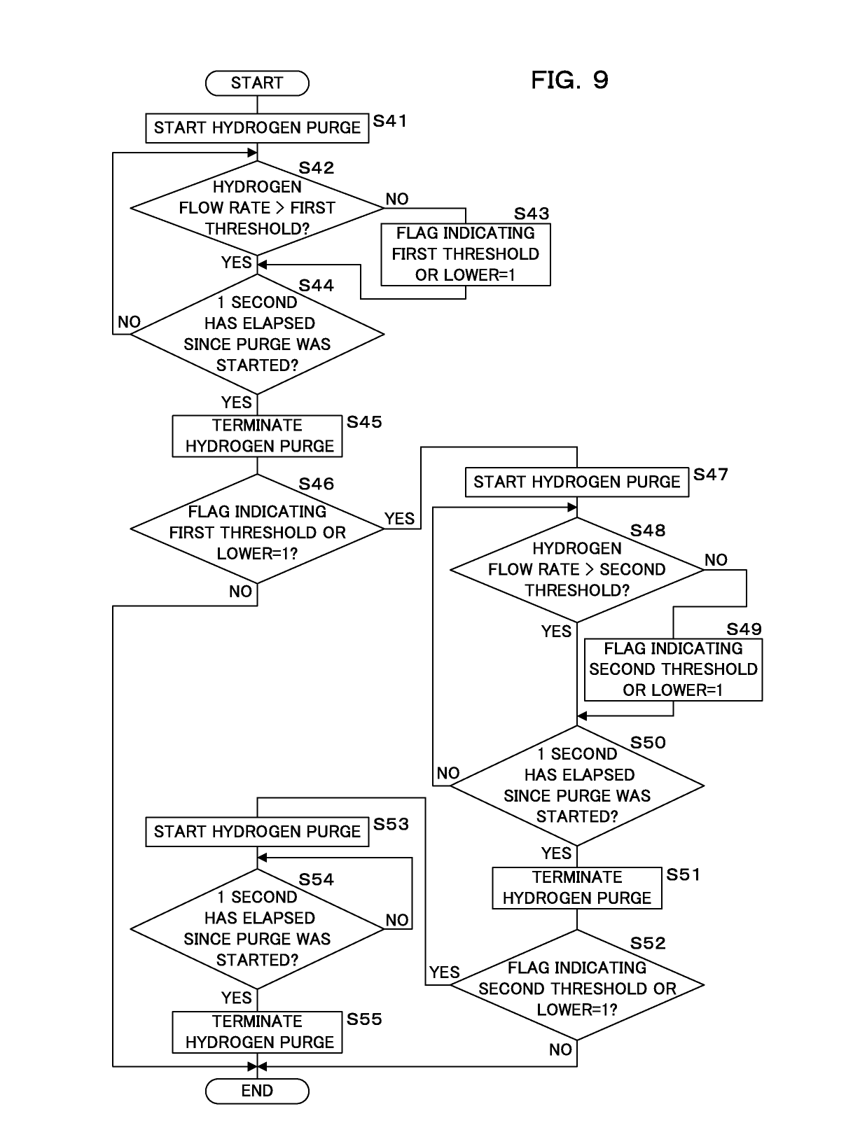

Next, control processing for the number of times of purge according to a third embodiment of the present disclosure is described below with reference to FIG. 9. On the basis of the detection result of the flowmeter 43 arranged in the middle of the fuel gas passage member 10 among the plurality of detection parts described above, the fuel cell system 1 of the present embodiment controls the number of times of purge performed by the third valve 14. In the following third embodiment, such control processing different from that of the first embodiment is described below. Then, detailed description is not given for control processing similar to that of the first embodiment.

Steps S41 to S46 illustrated in FIG. 9 respectively correspond to the control of the first purge at steps S1 to S6 of the first embodiment illustrated in FIG. 7. Steps S47 to S52 illustrated in FIG. 9 respectively correspond to the control of the second purge at steps S8 to S13 of the first embodiment illustrated in FIG. 7. Steps S53 to S55 illustrated in FIG. 9 respectively correspond to the control of the third purge at steps S15 to S17 of the first embodiment illustrated in FIG. 7.

The present embodiment is different from the first embodiment in the point that each of the first threshold and the second threshold at steps S42, S43, S46, S48, S49, S52, and S54 is the hydrogen flow rate of the fuel gas passage member 10. The amount of the gas discharged by the purge corresponds to the hydrogen flow rate. Thus, in the present embodiment, on the basis of the hydrogen flow rate detected by the flowmeter 43, the control part 40 determines whether the second purge is to be performed (steps S42, S43, S46) and whether the third purge is to be performed (steps S48, S49, S52).

Each of the hydrogen flow rates adopted as the first threshold and the second threshold is set to be a value required for the anode side in the inside of the fuel cell stack 100 being filled with a sufficient amount of hydrogen. In the present embodiment, as a specific example, the first threshold is set to be 40 NL/min and the second threshold is set to be 30 NL/min. Here, these values for the first threshold and the second threshold are merely examples. A hydrogen flow rate appropriate as each of the first threshold and the second threshold is determined in accordance with the inner volume of the fuel cell stack 100.

Further, the control of the second purge (S47 to S52) of the present embodiment does not contain the control corresponding to step S7 of the first embodiment. Similarly, the control of the third purge (S53 to S55) of the present embodiment does not contain the control corresponding to step S14 of the first embodiment. As described above, in the first embodiment, if the hydrogen pressure in the inside of the fuel gas passage member 10 exceeds the second threshold, the second purge and the third purge are started (steps S7, S8, S14, and S15). That is, in the first embodiment, the second purge and the third purge are started after the hydrogen pressure in the inside of the fuel gas passage member 10 having decreased in the preceding purge has increased to the second threshold. In contrast, in the present embodiment, whether the second purge is to be performed and whether the third purge is to be performed are determined on the basis of the hydrogen flow rate flowing through the fuel gas passage member 10. Since the fuel cell system 1 in the present embodiment is of dead end type, the hydrogen flow rate flowing through the fuel gas passage member 10 becomes approximately 0 if the closing operation of the third valve 14 is performed at steps S45 and S51. The hydrogen flow rate does not increase as long as the third valve 14 is in a closed state. Thus, in the present embodiment, after the completion of the first purge at steps S41 to S45, at step S46, if it is determined that the flag indicating that the hydrogen flow rate in the fuel gas passage member 10 is lower than the first threshold is “1” (YES), the second purge is started at step S47. Similarly, in the present embodiment, after the completion of the second purge at steps S47 to S51, at step S52, if it is determined that the flag indicating that the hydrogen flow rate in the fuel gas passage member 10 is lower than the second threshold is “1” (YES), the third purge is started at step S53.

According to the control processing of steps S41 to S55 illustrated in FIG. 9, similarly to the first embodiment, plural times of purge are allowed to be performed in a state of avoiding a situation that the supply of hydrogen to the fuel cell stack 100 is unintentionally stopped. As a result, the electricity generation efficiency of the fuel cell system 1 is not degraded by the plural times of purge.

<Control Processing for Number of Times of Purge According to Fourth Embodiment>

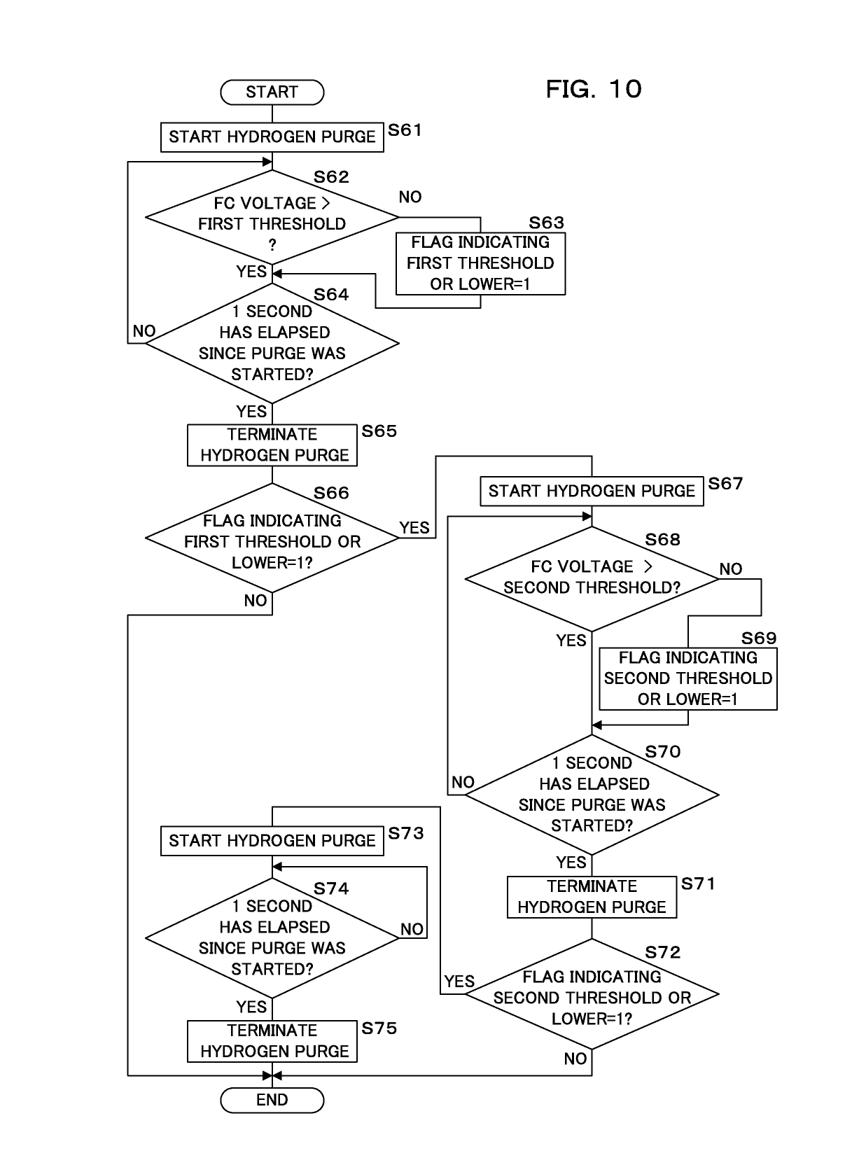

Next, control processing for the number of times of purge according to a fourth embodiment of the present disclosure is described below with reference to FIG. 10. On the basis of the detection result of the voltage detection part 44 provided in the fuel cell stack 100 among the plurality of detection parts described above, the fuel cell system 1 of the present embodiment controls the number of times of purge performed by the third valve 14.

Steps S61 to S66 illustrated in FIG. 10 respectively correspond to the control of the first purge at steps S1 to S6 of the first embodiment illustrated in FIG. 9. Steps S67 to S72 illustrated in FIG. 10 respectively correspond to the control of the second purge at steps S8 to S13 of the first embodiment illustrated in FIG. 7. Steps S73 to S75 illustrated in FIG. 10 respectively correspond to the control of the third purge at steps S15 to S17 of the first embodiment illustrated in FIG. 7.

The present embodiment is different from the first embodiment in the point that each of the first threshold and the second threshold at steps S62, S63, S66, S68, S69, and S72 is the FC voltage. At the time of startup of the fuel cell system 1, in a case that the air in the fuel gas passage member 10 is not sufficiently replaced with hydrogen, the FC voltage becomes lower in comparison with a case that the inside of the fuel gas passage member 10 is sufficiently replaced with hydrogen. Thus, in the present embodiment, on the basis of the FC voltage detected by the voltage detection part 44, the control part 40 determines whether the second purge is to be performed (steps S62, S63, and S66) and whether the third purge is to be performed (steps S68, S69, and S72).

Each of the FC voltages adopted as the first threshold and the second threshold is set to be a value required for checking that the anode side in the inside of the fuel cell stack 100 has been filled with a sufficient amount of hydrogen. In the present embodiment, as a specific example, the first threshold is set to be 45 V and the second threshold is set to be 43 V. Here, these values for the first threshold and the second threshold are merely examples. An FC voltage appropriate as each of the first threshold and the second threshold is determined in accordance with the number of stacked cells 101a constituting the fuel cell stack 100.

Further, the control of the second purge (S67 to S72) of the present embodiment does not contain the control corresponding to step S7 of the first embodiment. Similarly, the control of the third purge (S73 to S75) of the present embodiment does not contain the control corresponding to step S14 of the first embodiment. As described above, in the first embodiment, if the hydrogen pressure in the inside of the fuel gas passage member 10 exceeds the second threshold, the second purge and the third purge are started (steps S7, S8, S14, and S15). That is, in the first embodiment, the second purge and the third purge are started after the hydrogen pressure in the inside of the fuel gas passage member 10 having decreased in the preceding purge has increased to the second threshold. In contrast, in the present embodiment, whether the second purge is to be performed and whether the third purge is to be performed are determined on the basis of the FC voltage of the fuel cell stack 100. For example, at the time of startup of the fuel cell system 1, if it is determined that the FC voltage is not greater than the first threshold (YES at step S62), a high possibility is concluded that the air in the fuel gas passage member 10 is not replaced with a sufficient amount of hydrogen. In such a case, the FC voltage does not increase unless the air in the fuel gas passage member 10 is replaced with a sufficient amount of hydrogen by the second purge and the third purge. Thus, in the present embodiment, after the completion of the first purge at steps S61 to S65, at step S66, if it is determined that the flag indicating that the hydrogen flow rate in the fuel gas passage member 10 is lower than the first threshold is “1” (YES), the second purge is started at step S67. Similarly, in the present embodiment, after the completion of the second purge at steps S67 to S71, at step S72, if it is determined that the flag indicating that the hydrogen flow rate in the fuel gas passage member 10 is lower than the second threshold is “1” (YES), the third purge is started at step S73.

According to the control processing of steps S61 to S75 illustrated in FIG. 10, similarly to the first embodiment, plural times of purge are allowed to be performed in a state of avoiding a situation that the supply of hydrogen to the fuel cell stack 100 is unintentionally stopped. As a result, the electricity generation efficiency of the fuel cell system 1 is not degraded by the plural times of purge have.

<Other Changes>

The fuel cell system of the present disclosure is not limited to the first to the fourth embodiment given above. For example, in the control of the first to the fourth embodiment, each of the various detection parts detects the hydrogen pressure, the HM temperature, the hydrogen flow rate, or the FC voltage (steps S2, S9, S22, S29, S42, S48, S62, S68) during the execution of hydrogen purge. However, the detection timing of the detection part is not limited to that during the execution of hydrogen purge. The detection timing of the detection part may be any timing within the “time of purge” including a timing immediately prior to the start of the hydrogen purge, a timing during the execution, and a timing immediately posterior to the termination. For example, FIG. 7 discloses an example that the detection timing is during the execution of the first purge. However, for example, in a case that the detection timing is immediately prior to the start of the first purge, steps S2 and S3 are performed before step S1. On the other hand, in a case that the detection timing is immediately posterior to the termination of the first purge, steps S2 and S3 are performed between S5 and S6. In either case, the detection timing may be regarded as the “time of purge”. Further, the detection result of the detection part is not limited to the hydrogen pressure, the HM temperature, the hydrogen flow rate, or the FC voltage. For example, whether the second purge and the third purge are to be performed may be determined on the basis of a physical quantity relevant to at least one of the fuel gas supply source, the fuel gas passage member, and the fuel cell stack.

The present disclosure has been described above with reference to the embodiments. However, it is not an overemphasis to say that the present disclosure is not limited to the embodiments given above and may be applied in a state of being suitably changed within an extent of not deviating from the spirit.

It is noted that, as used herein and in the appended claims, the singular forms “a”, “an”, and “the” include plural referents unless the context clearly dictates otherwise.

What is claimed is:

1. A fuel cell system comprising:
a fuel cell stack in which a plurality of membrane electrode assemblies each having an anode electrode and a cathode electrode to which fuel gas and oxidation gas are supplied respectively for electric power generation are stacked with a plurality of separators;
a fuel gas passage member in which the fuel cell stack is connected in a middle and a fuel gas supply source containing a hydrogen absorbing alloy is connected to one end;
a purge valve arranged in the fuel gas passage member on a side opposite to the fuel gas supply source with respect to the fuel cell stack and allowed to switch between an open state and a closed state;
a detection part provided in at least one of the fuel gas passage member and the fuel cell stack and detecting a physical quantity relevant to at least one of the fuel gas supply source, the fuel gas passage member, and the fuel cell stack;
a first purge part, at a given purge timing, controlling switchover between the open state and the closed state of the purge valve so as to perform first purge;
a first determination part, on the basis of a first detection result detected by the detection part at the time of the first purge, determining whether second purge is to be performed after the first purge; and
a second purge part, in accordance with determination by the first determination part that the second purge is to be performed, controlling switchover between the open state and the closed state of the purge valve so as to perform the second purge.

2. The fuel cell system according to claim 1, further comprising a first comparison part comparing the first detection result with a first threshold, wherein
the first determination part, if a comparison result of the first comparison part indicates that the first detection result is greater than the first threshold, determines that the second purge is not to be performed and, if the comparison result of the first comparison part indicates that the first detection result is not greater than the first threshold, determines that the second purge is to be performed.

3. The fuel cell system according to claim 2, wherein the second purge part, if the comparison result of the first comparison part indicates that the first detection result is not greater than the first threshold, performs a control of, after a second detection result detected after obtaining the first detection result reaches a second threshold, performing the second purge.

4. The fuel cell system according to claim 1, comprising:
a second determination part, on the basis of the second detection result detected by the detection part at the time of the second purge, determining whether third purge is to be performed after the second purge; and
a third purge part, in accordance with determination by the second determination part that the third purge is to be performed, controlling switchover between the open state and the closed state of the purge valve so as to perform the third purge.

5. The fuel cell system according to claim 2, comprising:
a second determination part, on the basis of the second detection result detected by the detection part at the time of the second purge, determining whether third purge is to be performed after the second purge; and
a third purge part, in accordance with determination by the second determination part that the third purge is to be performed, controlling switchover between the open state and the closed state of the purge valve so as to perform the third purge.

6. The fuel cell system according to claim 3, comprising:
a second determination part, on the basis of the second detection result detected by the detection part at the time of the second purge, determining whether third purge is to be performed after the second purge; and
a third purge part, in accordance with determination by the second determination part that the third purge is to be performed, controlling switchover between the open state and the closed state of the purge valve so as to perform the third purge.

7. The fuel cell system according to claim 6, further comprising a second comparison part comparing the second detection result with the second threshold, wherein
the second determination part, if a comparison result of the second comparison part indicates that the second detection result is greater than the second threshold, determines that the third purge is not to be performed and, if the comparison result of the second comparison part indicates that the second detection result is not greater than the second threshold, determines that the third purge is to be performed.

8. The fuel cell system according to claim 7, wherein the third purge part, if the comparison result of the second comparison part indicates that the second detection result is not greater than the second threshold, performs a control of, after a third detection result detected after obtaining the second detection result reaches the second threshold, performing the third purge.

9. The fuel cell system according to claim 3, wherein the second threshold is smaller than the first threshold.

10. The fuel cell system according to claim 1, wherein the detection part detects as the physical quantity at least one of a temperature of the fuel gas supply source, a pressure of the fuel gas flowing through the fuel gas passage member, a flow rate of the fuel gas flowing through the fuel gas passage member, and a voltage of the fuel cell stack.

11. The fuel cell system according to claim 2, wherein the detection part detects as the physical quantity at least one of a temperature of the fuel gas supply source, a pressure of the fuel gas flowing through the fuel gas passage member, a flow rate of the fuel gas flowing through the fuel gas passage member, and a voltage of the fuel cell stack.

12. The fuel cell system according to claim 3, wherein the detection part detects as the physical quantity at least one of a temperature of the fuel gas supply source, a pressure of the fuel gas flowing through the fuel gas passage member, a flow rate of the fuel gas flowing through the fuel gas passage member, and a voltage of the fuel cell stack.

13. A control method for a purge valve in a fuel cell system including a fuel cell stack in which a plurality of membrane electrode assemblies each having an anode electrode and a cathode electrode are stacked with a plurality of separators a fuel gas passage member in which the fuel cell stack is connected in a middle and a fuel gas supply source containing a hydrogen absorbing alloy is connected to one end a purge valve arranged in the fuel gas passage member on a side opposite to the fuel gas supply source with respect to the fuel cell stack and allowed to switch between an open state and a closed state and a detection part provided in at least one of the fuel gas passage member and the fuel cell stack and detecting a physical quantity relevant to at least one of the fuel gas supply source, the fuel gas passage member, and the fuel cell stack, the control method comprising:
a first purge step of, at a given purge timing, controlling switchover between the open state and the closed state of the purge valve so as to perform first purge;
a first determination step of, on the basis of a first detection result detected by the detection part at the time of the first purge, determining whether second purge is to be performed after the first purge; and
a second purge step of, in accordance with determination at the first determination step that the second purge is to be performed, controlling switchover between the open state and the closed state of the purge valve so as to perform the second purge.

14. A fuel cell system comprising:
a stack in which a plurality of unit battery cells each including a membrane electrode assembly, having an anode electrode and a cathode electrode to which fuel gas and oxidation gas are supplied for electric power generation, are stacked together;
a fuel gas passage member in which the stack is connected in a middle and a fuel gas supply source containing a hydrogen absorbing alloy is connected to one end;
an anode side purge valve arranged in the fuel gas passage member on a side opposite to the fuel gas supply source with respect the stack;
a detection part provided in at least one of the fuel gas passage member and the stack and detecting a physical quantity relevant to at least one of the fuel gas supply source, the fuel gas passage member, and the stack;
a first purge part, at a given purge timing, controlling opening and closing of the anode side purge valve so as to perform first purge;
a first determination part, on the basis of a first detection result detected by the detection part at the time of the first purge, determining whether second purge is to be performed after the first purge;
a second purge part, in accordance with determination by the first determination part that the second purge is to be performed, controlling opening and closing of the anode side purge valve so as to perform the second purge; and
a first comparison part comparing the first detection result with a first threshold, wherein
the first determination part, if a comparison result of the first comparison part indicates that the first detection result is greater than the first threshold, determines that the second purge is not to be performed and, if the comparison result of the first comparison part indicates that the first detection result is not greater than the first threshold, determines that the second purge is to be performed, and
the second purge part, if a comparison result of the first comparison part indicates that the first detection result is not greater than the first threshold, after a second detection result detected after obtaining the first detection result reaches a second threshold, performs control of performing the second purge.

15. The fuel cell system according to claim 14, comprising:
a second determination part, on the basis of the second detection result detected by the detection part at the time of the second purge, determining whether third purge is to be performed after the second purge; and
a third purge part, in accordance with determination by the second determination part that the third purge is to be performed, controlling opening and closing of the anode side purge valve so as to perform the third purge.

16. The fuel cell system according to claim 15, further comprising a second comparison part comparing the second detection result with the second threshold, wherein
the second determination part, if a comparison result of the second comparison part indicates that the second detection result is greater than the second threshold, determines that the third purge is not to be performed and, if the comparison result of the second comparison part indicates that the second detection result is not greater than the second threshold, determines that the third purge is to be performed.

17. The fuel cell system according to claim 16, wherein the third purge part, if the comparison result of the second comparison part indicates that the second detection result is not greater than the second threshold, performs a control of, after a third detection result detected after obtaining the second detection result reaches the second threshold, performing the third purge.

18. The fuel cell system according to claim 14, wherein the second threshold is smaller than the first threshold.

19. The fuel cell system according to claim 15, wherein the second threshold is smaller than the first threshold.

20. The fuel cell system according to claim 14, wherein the detection part detects as the physical quantity at least one of a temperature of the fuel gas supply source, a pressure of the fuel gas flowing through the fuel gas passage member, a flow rate of the fuel gas flowing through the fuel gas passage member, and a voltage of the stack.
